(19) United States
(12) Patent Application Publication
(10) Pub. No.: US 2020/0355293 A1
(43) Pub. Date: Nov. 12, 2020

(54) CONTROL VALVE FOR CONTROLLING A FLOW OF FLUID MEDIUM AND METHOD OF FORMING A VALVE BODY INCLUDING THE SAME

(71) Applicant: BorgWarner Inc., Auburn Hills, MI (US)

(72) Inventor: Philip A. RUEHL, Auburn Hills, MI (US)

(21) Appl. No.: 16/866,765

(22) Filed: May 5, 2020

Related U.S. Application Data
(60) Provisional application No. 62/845,592, filed on May 9, 2019.

(51) Int. Cl. F16K 31/06; B23P 15/00

(52) U.S. Cl. CPC F16K 31/0665; B23P 15/001

(57) ABSTRACT

A control valve for controlling a flow of fluid medium includes a push rod extending along an axis and configured for movement between an unactuated position and an actuated position. The control valve also includes a valve member operably coupled to the push rod for controlling the flow of fluid medium. Additionally, the control valve includes a valve body having an interior surface defining a fluid passage. The valve body includes a push rod guide concentric with said fluid passage. The push rod guide is also disposed about said push rod along said axis for guiding said push rod between said unactuated position and said actuated position. The valve body also includes a push rod guide support disposed within said fluid passage. Finally, the push rod guide support is integral with and extends between said interior surface of said valve body and said push rod guide.

### RELATED APPLICATIONS

This application claims priority to and the benefit of U.S. Provisional Patent Application No. 62/845,592, filed on May 9, 2019, the entire contents of which are hereby incorporated by reference.

### BACKGROUND OF THE INVENTION

### 1. Field of the Invention

The subject invention relates generally to a hydraulic control solenoid and, more specifically, to a control valve for use in the hydraulic control solenoid.

### 2. Description of the Related Art

Conventional vehicle powertrain systems known in the art typically include an engine in rotational communication with a transmission. The engine generates rotational torque which is selectively translated to the transmission which, in turn, translates rotational torque to one or more wheels. Typical transmissions are shifted in discrete steps between a high-torque, low-speed mode for starting a vehicle and a high-speed, low-torque mode for vehicle operation at highway speeds. In a manual transmission, shifting is accomplished by the manual controlled engagement of gear sets. In an automatic transmission, shifting is accomplished by the automatic controlled engagement of friction elements.

To facilitate shifting and controlled engagement of the friction elements of the automatic transmission, the vehicle powertrain system typically includes a pump to provide pressurized hydraulic fluid, and a plurality of control valves for controlling a flow of fluid through a hydraulic circuit.

Conventional control valves used to control the flow of fluid through the hydraulic circuit include on-off solenoids with a push rod which has molded-on features to provide flow paths and guidance for movement. Another conventional design includes a short push rod rigidly attached to an armature, using the armature for guidance and providing the flow through an indirect path required to reach the valve operated by the shorter push rod. However, during cold temperatures the viscosity of the fluid increases, which in turn decreases the flow rate of the fluid through the control valve resulting in delayed and/or less overall control provided by the control valve. To increase the flow rate of the fluid through the control valve, conventional control valves decrease the thickness of the molded-on features to provide additional room for flow. However, having a push rod with less molded on material may lead to breakage of the push rod and failure of the control valve after repeated use. Specifically, the smaller molded features of the push rod may break during operation, leading to failure of the control valve. Furthermore providing the molded-on features of such a push rod requires an extra process during manufacturing which is desirable to eliminate. Other conventional designs integrate a valve with the push rod, requiring additional machining of the push rod and valve body and more costly materials. As such, there remains a need for an easily manufactured control valve which allows maximum flow of the fluid resulting in faster and more accurate control of the output flow or pressure, particularly during cold temperatures, while maintaining strength of the push rod to ensure repeatability.

### SUMMARY OF THE INVENTION AND ADVANTAGES

A control valve for controlling a flow of fluid medium is disclosed herein. The control valve includes a push rod extending along an axis and configured for movement between an unactuated position and an actuated position. The control valve also includes a valve member operably coupled to the push rod for controlling the flow of fluid medium. Additionally, the control valve includes a valve body having an interior surface defining a fluid passage. The valve body includes a push rod guide concentric with said fluid passage. The push rod guide is also disposed about said push rod along said axis for guiding said push rod between said unactuated position and said actuated position. The valve body also includes a push rod guide support disposed within said fluid passage. The push rod guide support is integral with and extends between said interior surface of said valve body and said push rod guide.

Finally, a method of forming the control valve is disclosed herein.

Having the push rod guide support integral with and extending between the interior surface of the valve body and the push rod guide allows for maximum cross-sectional area of the fluid passage to allow a maximum flow rate through the control valve, providing faster and more accurate valve control while still providing strength to the push rod to reduce push rod breakage to ensure repeatability.

### BRIEF DESCRIPTION OF THE DRAWINGS

Other advantages of the present invention will be readily appreciated as the same becomes better understood by reference to the following detailed description when considered in connection with the accompanying drawings, wherein:

FIG. 1A is a cross-sectional view of a control valve having a stepped push rod in an unactuated position;

FIG. 1B is a cross-sectional view of a control valve having a stepped push rod in an actuated position;

FIG. 2A is a cross-sectional view of the control valve having a straight push rod in an unactuated position;

FIG. 2B is a cross-sectional view of the control valve having a straight push rod in an actuated position;

FIG. 3A is a top view of a valve body of the control valve;

FIG. 3B is a top view of the valve body of the control valve having the push rod removed;

FIG. 3C is a side perspective view of the valve body of the control valve;

FIG. 4A is a cross-sectional view of the control valve of FIG. 1A emphasizing the flow of fluid medium and having the push rod in the unactuated position; and

FIG. 4B is a cross-sectional view of the control valve of FIG. 1B emphasizing the flow of fluid medium and having the push rod in the actuated position.

### DETAILED DESCRIPTION OF THE INVENTION

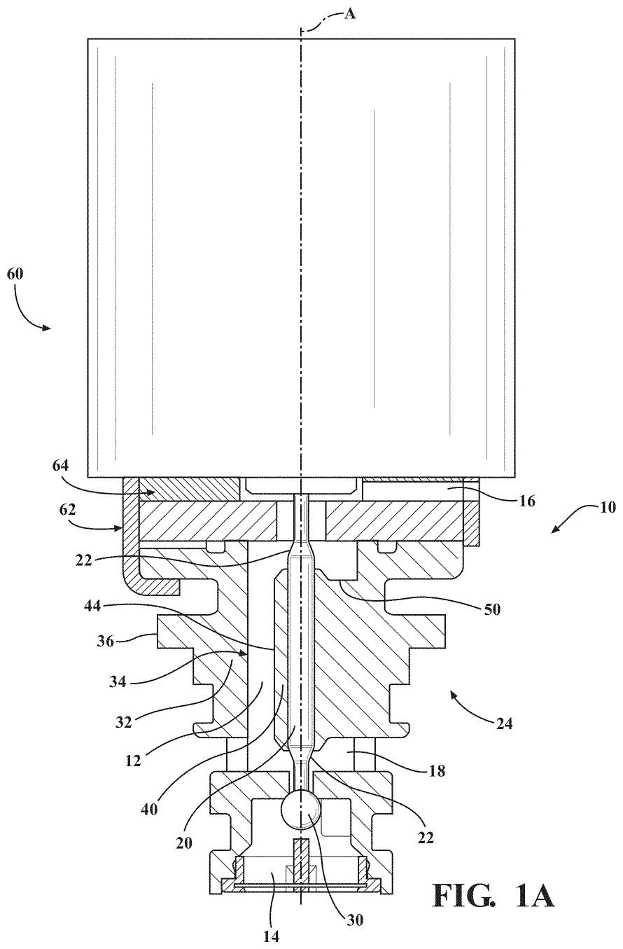

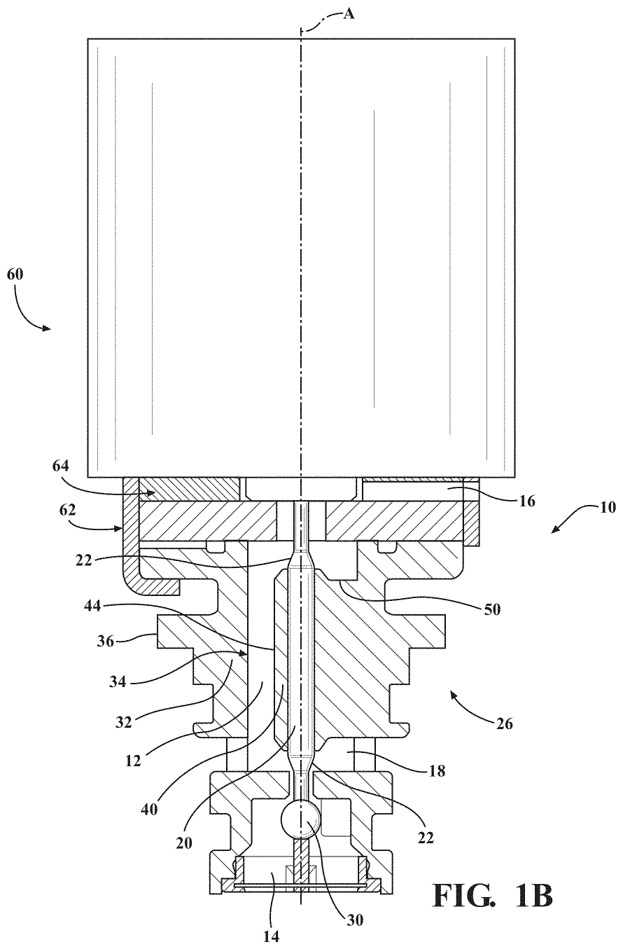

Referring now to the Figures, where like numerals are used to designate like structure unless otherwise indicated, a control valve 10 for controlling a flow of a fluid medium is generally shown in FIGS. 1A and 1B. It is to be appreciated that the control valve 10 may be a pressure control valve 10 or a flow control valve 10. Moreover, the control valve 10 may include one or more of any type of valve for the regulation of a fluid medium including a check valve, a poppet valve, a ball valve, a spool valve, or the like. Furthermore the control valve 10 may be actuated by any linear force including a solenoid, power screw, hydraulic actuator, pneumatic actuator or the like.

Referring still to FIGS. 1A and 1B, the control valve 10 defines a plurality of ports and a fluid passage 12 is defined between one or more of the ports. In the embodiment illustrated in FIG. 1A, the control valve 10 defines a supply port 14 configured to allow flow of the fluid medium to enter a fluid passage 12 of the control valve 10, an exhaust port 16 configured to allow flow of the fluid medium to exit the fluid passage 12, and a control port 18 configured to control the flow of fluid medium, i.e. to allow the flow of fluid medium to enter or exit the fluid passage 12. In one embodiment, the control port 18 is connected to the fluid passage 12 and connected to either supply port 14 or exhaust port 16 as determined by the actuation state of the valve. Therefore, in the embodiment illustrated in FIG. 1A, the fluid passage 12 is defined between the control port 18 and the exhaust port 16. However, it is also contemplated that the fluid passage 12 may be defined between the supply port 14 and the control port 18 and/or between the control port 18 and the exhaust port 16, if desired. However, the supply port 14, the exhaust port 16, and the control port 18 may function as any type of port as desired by one of ordinary skill in the art. Moreover, the control valve 10 may define any number of ports, including more or fewer inlet ports, outlet ports, and/or control ports 18.

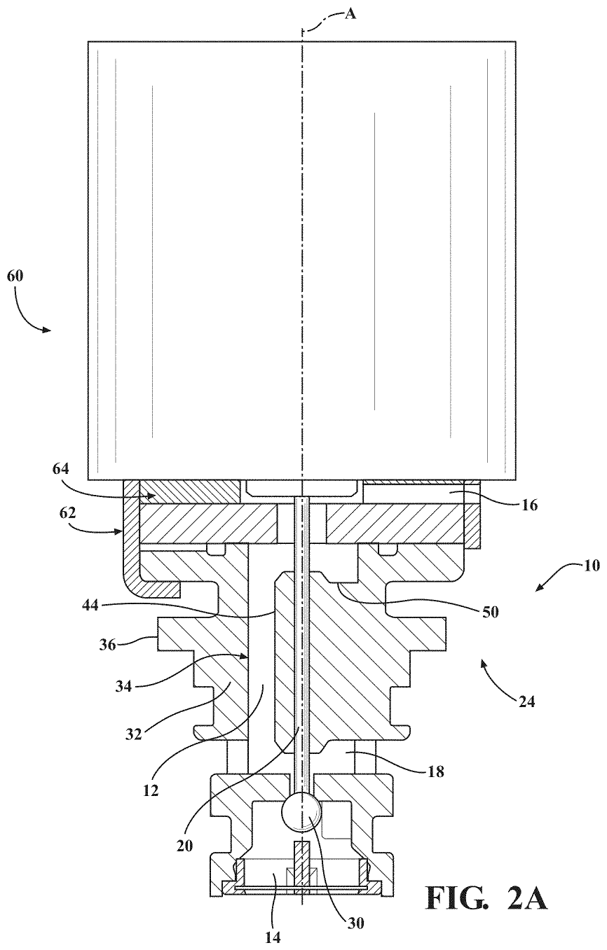

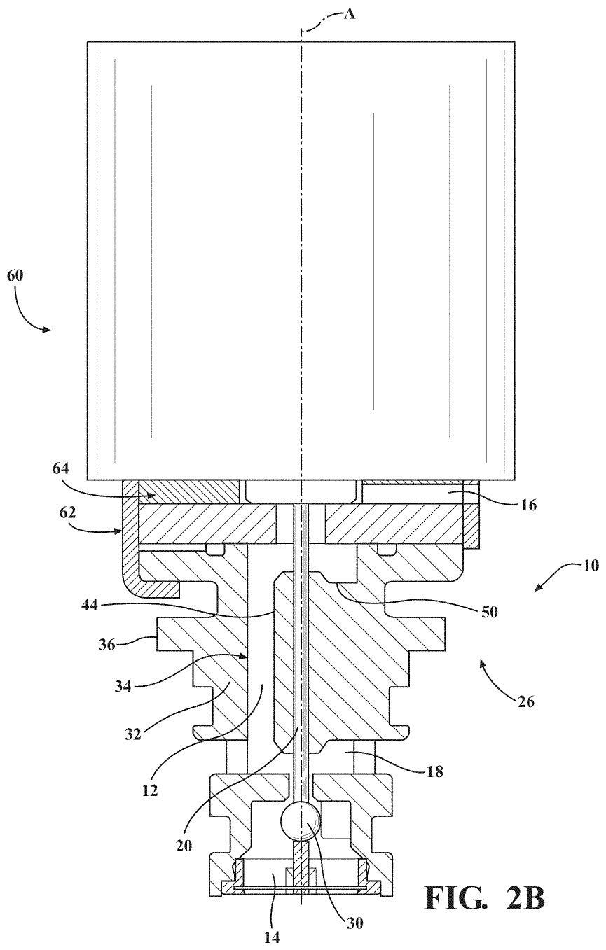

Referring now to the embodiments illustrated in FIGS. 1A-2B, the control valve 10 includes a push rod 20 extending along an axis. In the embodiment illustrated in FIG. 1, the axis is a longitudinal axis A centrally located along the control valve 10. However, it is also contemplated that the axis A may be a longitudinal axis located anywhere along the control valve 10 or a latitudinal axis located anywhere along the control valve 10, if desired. It is contemplated that the push rod 20 may be comprised of steel; however, it is also contemplated that the push rod 20 may be comprised of aluminum, a plastic, or a composite material, as desired by one of ordinary skill in the art. In the embodiment illustrated in FIGS. 2A and 2B, the push rod 20 is generally cylindrical and has a single diameter along an entire length of the push rod 20. However, in another embodiment, illustrated in FIGS. 1A and 1B, the push rod 20 has multiple diameters along the length of the push rod 20. The multiple diameters may be in the form of a stepped portion 22, or the push rod 20 may include various diameters throughout the length, such as an increasing diameter in a direction from the supply port 14 to the exhaust port 16, or a decreasing diameter in a direction from the supply port 14 to the exhaust port 16. In the embodiment including the stepped portion 22 of the push rod 20, as best illustrated in FIGS. 1A and 1B, the stepped portion 22 may function to direct the fluid medium though the fluid passage 12 and away from other portions of the control valve 10. As such, it is contemplated that the push rod 20 may include more than one stepped portion 22, and the stepped portion(s) 22 may be of any degree and/or shape.

Moreover, the push rod 20 is configured for movement between an unactuated position 24 and an actuated position 26. In the unactuated position 24, illustrated in FIGS. 1A and 2A, the push rod 20 is disposed towards the exhaust port 16. In the actuated position 26, illustrated in FIGS. 1B and 2B, the push rod 20 is disposed towards the supply port 14. In the embodiments illustrated in FIGS. 1A-2B, the push rod 20 slides in a longitudinal direction along the axis A between the unactuated position 24 and the actuated position 26. However, it is also contemplated that the push rod 20 may move between the unactuated position 24 and the actuated position 26 using any type of movement, including rotational or linear movement in any direction, or a combination of linear and rotational movement.

The control valve 10 also includes a valve member 30. The valve member 30 is operably coupled to the push rod 20 for controlling the flow of the fluid medium. In other words, when the push rod 20 is in the unactuated position 24, the push rod 20 is disposed towards the exhaust port 16 and may not be engaged with the valve member 30 such that the valve member 30 at least partially prevents flow through the supply port 14, allowing minimum or no flow of the fluid medium from the supply port 14 through the fluid passage 12. However, when the push rod 20 is in the actuated position 26, the push rod 20 engages the valve member 30 and moves the valve member 30 such that the valve member 30 allows maximum flow of the fluid medium from the supply port 14 through the fluid passage 12. The push rod 20 may also be moved to a location between the unactuated position 24 and the actuated position 26, which would in turn allow various flow rates through the fluid passage 12.

Moreover, in the embodiment illustrated in FIGS. 1A and 1B, the valve member 30 is disposed between the supply port 14 and the control port 18 which increases the flow to the control port 18, allowing maximum control of the control valve 10. However, it is also contemplated that the valve member 30 or an additional valve member may be disposed elsewhere within the control valve 10, including, but not limited to, between the supply port 14 and the exhaust port 16, or between the control port 18 and the exhaust port 16. In the embodiment illustrated in FIGS. 1A and 1B, the valve member 30 is a ball. More specifically, the valve member 30 is spherical shaped and sized to control the flow of the fluid medium depending on a position of the ball. It is also contemplated that the valve member 30 may be any shape or size configured to control the flow of the fluid medium.

The control valve 10 also includes a valve body 32. The valve body 32 has an interior surface 34 which defines the fluid passage 12. Generally, the fluid passage 12 extends from the supply port 14 to the exhaust port 16 and to the control port 18, allowing precise control of the flow rate of the fluid medium. It is contemplated that the interior surface 34 of the valve body 32 may define the entire fluid passage 12, or only a portion of the fluid passage 12. Maximizing the cross-sectional area of the fluid passage 12 is necessary to provide optimal flow of the fluid medium from the supply port 14 to the exhaust port 16. Moreover, the valve body 32 also has an exterior surface 36 disposed opposite the interior surface 34 which may engage other systems or components. As such, the exterior surface 36 may be any shape or size, and may include one or more protrusions configured to engage or be placed proximal with various other components or systems not shown here.

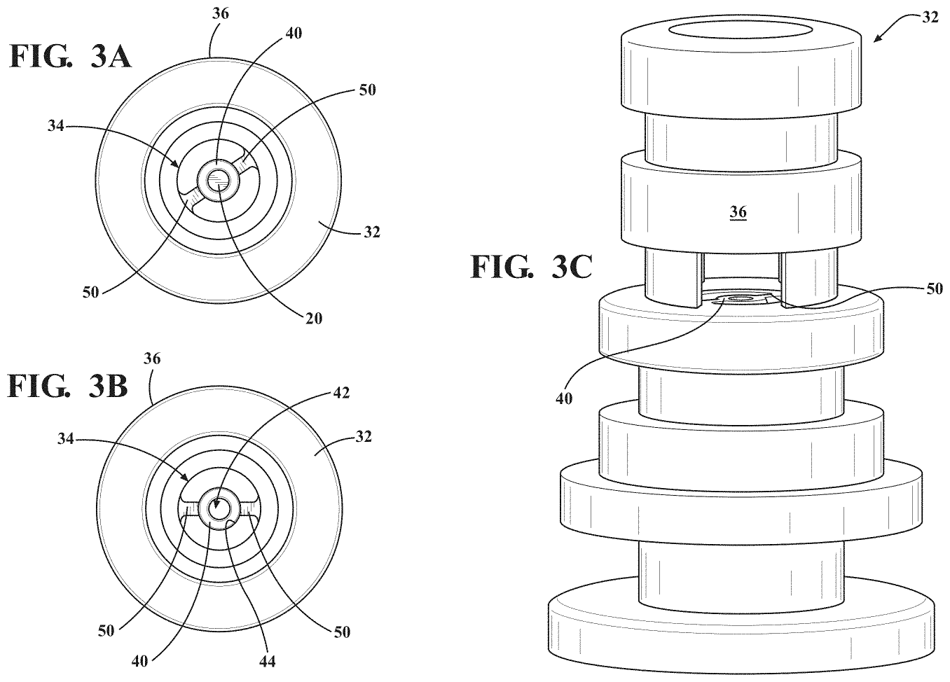

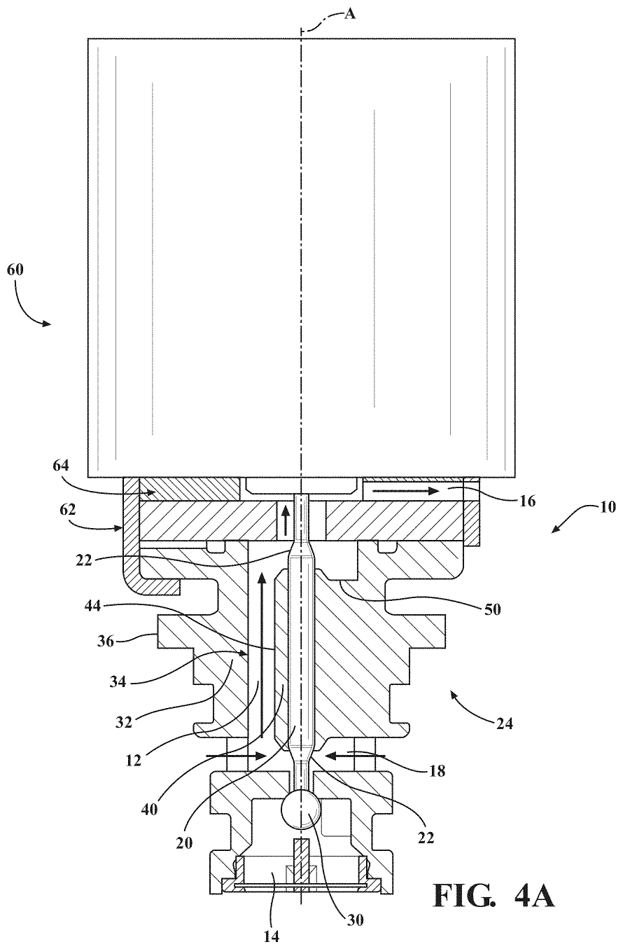

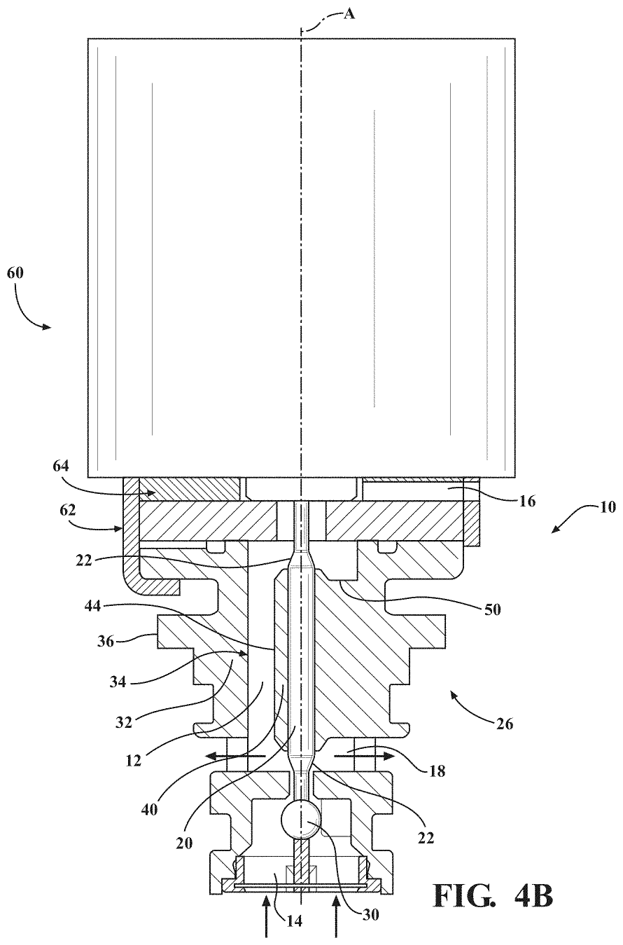

The valve body 32 also includes a push rod guide 40 concentric with the fluid passage 12. As illustrated in the embodiment illustrated in FIGS. 1A and 1B, the push rod guide 40 may have a length along the axis A, including, but not limited to, an entire length of the push rod 20, a length of the larger diameter portion of the push rod 20, or a length of any portion of the length of the push rod 20. Moreover, the push rod guide 40 is disposed about the push rod 20 along the axis A for guiding the push rod 20 between the unactuated position 24 and the actuated position 26. More specifically, as illustrated in FIG. 3B, the push rod guide 40 defines an aperture 42 for guiding the push rod 20 between the unactuated position 24 and the actuated position 26 as the push rod 20 is disposed within the aperture 42. In the embodiment illustrated in FIGS. 1A and 1B, the aperture 42 is cylindrical in shape and has a single diameter throughout a length of the aperture 42. However, it is also contemplated that the aperture 42 may include multiple diameters throughout its length using one or more protrusions, a stepped design, or a gradual diameter change. Moreover, it is contemplated that the aperture 42 may be any shape including, but not limited to oval, square, triangular, or the like. The aperture 42 of the push rod guide 40 is configured to allow the push rod 20 to slide between the unactuated position 24 and the actuated position 26. It is contemplated that the aperture 42 may be sized such that an inside surface which defines the aperture 42 contacts at least a portion of the push rod 20 in one or more positions of the push rod 20. However, it is also contemplated that a space may be present between the push rod 20 and the inside surface of the aperture 42 to allow for a small amount of the fluid medium or other lubricant to be disposed between the push rod guide 40 and the push rod 20.

As best illustrated in FIG. 1A, the push rod guide 40 has an outer surface 44 which defines the fluid passage 12. More specifically, the fluid passage 12 is disposed between the interior surface 34 of the valve body 32 and the outer surface 44 of the push rod guide 40. This allows the fluid passage 12 to surround the push rod guide 40 giving maximum cross-sectional area for the fluid passage 12, which increases flow of the fluid medium through the fluid passage 12. Moreover, this arrangement permits the valve member 30 to be located between the supply port 14 and control port 18 which increases flow to the control port 18, providing better control by the control valve 10.

Referring again to the embodiment illustrated in FIGS. 3A-C, the valve body 32 also includes a push rod guide support 50 disposed within the fluid passage 12. It is contemplated that the valve body 32 may include any number of push rod guide supports 50, including, but not limited to, one, two, three, four, five, or the like. In the embodiment illustrated in FIGS. 3A-3C, the push rod guide support 50 is integral with and extends between the interior surface 34 of the valve body 32 and the push rod guide 40. The push rod guide support 50 is configured to maintain the position of the push rod guide 40 during operation of the control valve 10. In other words, the push rod guide support 50 anchors the push rod guide 40 in place to maintain the position of the push rod guide 40 when the push rod 20 is in any location, including when the push rod 20 is in the actuated position 26, when the push rod 20 is in the unactuated position 24, and when the push rod 20 is between the actuated position 26 and the unactuated position 24.

As best illustrated in FIGS. 1A and 1B, it is contemplated that the push rod guide support 50 may interrupt the flow path of the fluid medium such that the fluid passage 12 is partially defined by the push rod guide support 50. As best illustrated in FIGS. 3A-3C, the push rod guide support 50 has a generally rectangular cross-section which extends between the push rod guide 40 and the interior surface 34 of the valve body 32. However, it is also contemplated that the push rod guide support 50 may have any other shaped cross-section including, but not limited to, square, circular, trapezoidal, or the like. In the embodiment illustrated in FIGS. 3A and 3B the valve body 32 includes two push rod guide supports 50. The two push rod guide supports 50 extend opposite one another such that the two push rod guide supports 50, along with the push rod guide 40, form a line. However, it is also contemplated that multiple push rod guide supports 50 may be disposed elsewhere about the push rod guide 40. The push rod guide support 50 is sized and shaped to provide the necessary strength to prevent lateral movement of the push rod guide 40 while providing the largest cross-sectional area for the fluid passage 12. As such, the valve body 32 described herein allows the push rod 20 to be able to move between the unactuated position 24 and the actuated position 26 with repeatability and accuracy, when desired, while maximizing the flow of the fluid medium through the fluid passage 12 to allow for maximum control by the control valve 10.

As described above, previously known ball-type control valves have a fluid passage 12 having cross-sectional area of approximately 9.8 mm². This small cross-sectional area results in decreased flow rates from the control port 18 to the exhaust port 16 which leads to decreased control by the control valve 10, especially during vehicle warm-up. However, the control valve 10 described herein includes the integral push rod guide 40 and push rod guide support 50 which has a length of approximately 12.4 mm and a width of approximately 1.5 mm. In this embodiment, the push rod guide support 50 allows the fluid passage 12 to have a cross-sectional area of approximately 26.2 mm². The increased size of the fluid passage 12 provides increased flow from the control port 18 to the exhaust port 16, resulting in improved control by the control valve 10.

In one embodiment, the valve body 32 is comprised of a single material. More specifically, in one embodiment, the interior surface 34 of the valve body 32, the push rod guide 40, and the push rod guide support 50 are comprised of a single material. As used herein, the valve body 32 being comprised of a “single material” means that all elements of the valve body 32 are comprised of the same material. That same material may be a polymer, aluminum, steel, or a composite material comprising more than one material type. Moreover, in one embodiment, the valve body 32 is a casted element such that the valve body 32 is formed as a single integral piece. In one embodiment, the valve body 32 is a single piece injection molded plastic piece. However, it is also contemplated that the valve body 32 may be formed by a different process which produces the valve body 32 as a single integral piece.

With reference to FIGS. 1A-2B, the control valve 10 may include an actuator 60 operably coupled to the push rod 20 for moving the push rod 20 between the unactuated position 24 and the actuated position 26. The actuator 60 may be any suitable actuator for moving the push rod 20, such as a solenoid actuator. In one embodiment, the control valve 10 further includes a solenoid housing 62 disposed about the axis A and defining a solenoid interior 64. In such embodiments, the actuator 60 is further defined as a solenoid actuator. The solenoid actuator may include a coil disposed about the axis A and in the solenoid interior 64.

A method of forming the valve body 32 for the control valve 10 includes the step of integrally forming the interior surface 34, the push rod guide 40, and the push rod guide support 50 from the single material such that the push rod guide support 50 is integral with and extends between the interior surface 34 and the push rod guide 40. In one embodiment, the step of integrally forming the interior surface 34, the push rod guide 40, and the push rod guide support 50 includes injection molding the interior surface 34, the push rod guide 40, and the push rod guide support 50. It is contemplated that the push rod guide support 50 may be injection molded using plastic, aluminum, or another material, as desired. Additionally, the push rod guide 40 may define the aperture 42 which extends along the axis A, and the method of forming the control valve 10 also includes inserting the push rod 20 into the aperture 42 of the push rod guide 40.

Having the push rod guide support 50 integral with and extending between the interior surface 34 of the valve body 32 and the push rod guide 40 allows for maximum cross-sectional area of the fluid passage 12 to allow a maximum flow rate through the control valve 10, providing faster and more accurate control of the control valve 10 while still providing strength to the push rod to ensure repeatability. Moreover, the manufacturing process of the control valve 10 is streamlined and includes minimum steps reducing overall cost of the control valve.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

What is claimed is:

1. A control valve for controlling a flow of fluid medium, said control valve comprising:
a push rod extending along an axis and configured for movement between an unactuated position and an actuated position;
a valve member operably coupled to said push rod for controlling the flow of fluid medium; and
a valve body having an interior surface defining a fluid passage, said valve body comprising:
a push rod guide concentric with said fluid passage and disposed about said push rod along said axis for guiding said push rod between said unactuated position and said actuated position; and
a push rod guide support disposed within said fluid passage,
wherein said push rod guide support is integral with and extends between said interior surface of said valve body and said push rod guide.

2. The control valve as set forth in claim 1, wherein said control valve defines a supply port configured to allow flow of the fluid medium to enter said fluid passage, an exhaust port configured to allow flow of the fluid medium to exit said fluid passage, and a control port configured to control a flow rate of the fluid medium.

3. The control valve as set forth in claim 2, wherein said valve member is disposed between said supply port and said control port.

4. The control valve as set forth in claim 1, wherein said push rod has a single diameter along an entire length of said push rod.

5. The control valve as set forth in claim 1, wherein said push rod has more than one diameter along a length of said push rod.

6. The control valve as set forth in claim 5, wherein said push rod is stepped.

7. The control valve as set forth in claim 1, wherein said valve member is a ball.

8. The control valve as set forth in claim 1, wherein said push rod guide comprises an inside surface which defines an aperture for guiding said push rod between said unactuated position and said actuated position and said push rod is disposed within said aperture.

9. The control valve as set forth in claim 8, wherein said push rod guide support comprises at least two push rod guide supports integral with and extending between said interior surface of said valve body and said push rod guide.

10. The control valve as set forth in claim 1, wherein said fluid passage has a cross-sectional area of approximately 26.2 mm².

11. The control valve as set forth in claim 1, wherein said valve body comprises a single material, said single material comprising a polymer.

12. The control valve as set forth in claim 1, wherein said valve body comprises a single material, said single material comprising aluminum.

13. The control valve as set forth in claim 1, further comprising an actuator operably coupled to said push rod for moving said push rod between said unactuated position and said actuated position.

14. The control valve as set forth in claim 13, further comprising a solenoid housing disposed about said axis and defining a solenoid interior, wherein said actuator is further defined as a solenoid actuator comprising a coil disposed about said axis and in said solenoid interior, and an armature disposed in said solenoid interior and slideable along said axis in response to energization of said coil to move said push rod between said unactuated position and said actuated position.

15. A method of forming a valve body for a control valve, with the control valve comprising a push rod extending along an axis and configured for movement between an unactuated position and an actuated position; and a valve member operably coupled to said push rod for controlling the flow of fluid medium; said method comprising the step of:
integrally forming an interior surface, a push rod guide, and a push rod guide support from a single material such that the push rod guide support is integral with and extends between the interior surface and the push rod guide.

16. The method as set forth in claim 15, wherein the step of forming the interior surface, the push rod guide, and the push rod guide support comprises injection molding the interior surface, the push rod guide, and the push rod guide support.

17. The method as set forth in claim 15, with the push rod guide defining an aperture extending along the axis, said method further comprising the step of inserting the push rod into the aperture of the push rod guide.

18. The method as set forth in claim 16, wherein the step of forming the interior surface, push rod guide, and the push rod guide support comprises using aluminum to injection mold the interior surface, the push rod guide, and the push rod guide support.
